(19) United States
(12) Patent Application Publication
(10) Pub. No.: US 2005/0079401 A1
(43) Pub. Date: Apr. 14, 2005

(54) Fuel cell stack simulator

(76) Inventor: Yong Seon Park, Yongin-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,887

(22) Filed: Dec. 29, 2003

(30) Foreign Application Priority Data
Oct. 10, 2003 (KR) 10-2003-0070621

(51) Int. Cl. H01M 8/02; H01M 8/04

(52) U.S. Cl. 429/38; 429/26; 429/25; 429/24

(57) ABSTRACT

A fuel cell stack simulator comprises an air flow field being supplied with air and exhausting the remains of the supplied air to outside after heating the supplied air and reducing the pressure of the supplied air. A fuel flow field is supplied with fuel gas and exhausts the remains of the supplied fuel gas to the outside after heating the supplied fuel gas and reducing the pressure of the supplied fuel gas. A coolant flow field is supplied with coolant and exhausts the supplied coolant to outside after heating the supplied coolant and reducing the pressure of the coolant. A moisture-supplying field supplies moisture into the fuel cell stack simulator. An air-consuming field is connected to the air-supplying field and derives a portion of the air heated air with reduced pressure. A fuel-gas-consuming field is connected to the fuel-gas-supplying field and derives a portion of the heated fuel gas with reduced pressure.

### CROSS-REFERENCE TO RELATED APPLICATIONS

This application claims priority of Korean Application No. 10-2003-0070621, filed Oct. 10, 2003 , the disclosure of which is incorporated fully herein by reference.

### FIELD OF THE INVENTION

This invention relates to a fuel cell system, and more particularly to a fuel cell stack stimulator which can be substituted for a fuel cell stack when estimating characteristics of BOP (Balance of Plant), such as an air blower, a coolant pump, a radiator, an accumulator, an ion remover, a mass flowmeter, and a plurality of sensors.

### BACKGROUND OF THE INVENTION

When the fuel cell system is installed in a laboratory, the fuel cell system is called a “breadboard.” When the fuel cell stack or a BOP (Balance of Plant) of the fuel cell system is developed, the breadboard is installed and operated in order to estimate or inspect the characteristics of the fuel cell system.

When evaluating the breadboard installed in the laboratory, a variety of operating conditions including the pressure and the temperature of the fluids in the flow fields is applied to the breadboard such that the BOP, which is adapted to the breadboard, is estimated, and optimum specifications of the BOP are determined.

However, when the newly developed BOP is applied to the breadboard, the performance of the BOP is not yet guaranteed such that the fuel cell stack can deteriorate. Accordingly, when the fuel cell stack deteriorates, it should be replaced with a new one, such that disutility is caused, thereby limiting a variety of operating conditions to the breadboard.

### SUMMARY OF THE INVENTION

The motivation for the present invention is to address the above problems, and, accordingly, to provide a fuel cell stack simulator having non-limiting advantages of providing a fuel cell stack simulator which can be substituted with a fuel cell stack in the case that the BOP of the fuel cell system is to be estimated.

An exemplary fuel cell stack simulator according to the present invention includes an air flow field supplied with air and exhausting remains of the supplied air after heating the supplied air and reducing the pressure of the supplied air. This fuel cell stack should also include: a fuel flow field supplied with fuel gas and exhausting remains of the supplied fuel gas after heating the supplied fuel gas and reducing the pressure of the supplied fuel gas; a coolant flow field supplied with coolant and exhausting the supplied coolant after heating the supplied coolant and reducing the pressure of the coolant; a moisture-supplying field for supplying moisture into the fuel cell stack simulator; an air-consuming field connected to the air-supplying field for reducing the pressure of a portion of the air heated air; and a fuel-gas-consuming field connected to the fuel-gas-supplying field for reducing the pressure of a portion of the heated fuel gas.

Preferably, each of the air flow field, the fuel flow field, and the coolant flow field comprises a control valve for reducing the pressure of the flow therethrough, and a heater for heating the flow therethrough. Preferably, each of the air flow field, the fuel flow field, and the coolant flow field is provided with a temperature sensor and a pressure sensor disposed in an inlet and an outlet thereof. Preferably, each of the control valves is controlled on the basis of the pressures detected by the pressure sensors. Preferably, each of the heaters is controlled on the basis of the temperatures detected by the temperature sensors. Preferably, each of the air-consuming field and the fuel-gas-consuming field has a mass flow meter for detecting the flow rate, and a pump for deriving a portion of the flow thereof.

Furthermore, preferably, the pump is controlled on the basis of the flow rate detected by the mass flow meter. Preferably, the moisture-supplying field has a pump for introducing water, a mass flow meter for detecting the flow rate of the introduced water, a heater for heating the introduced water, and an injector for injecting the heated water into the air flow field as moisture. Preferably, the pump of the moisture-supplying field is controlled on the basis of the flow rate detected by the mass flow meter of the moisture-supplying field.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 is a block diagram showing a fuel cell system.

FIG. 2 illustrates a construction of the fuel cell stack simulator.

### DETAILED DESCRIPTION OF THE PREFERRED EMBODIMENTS

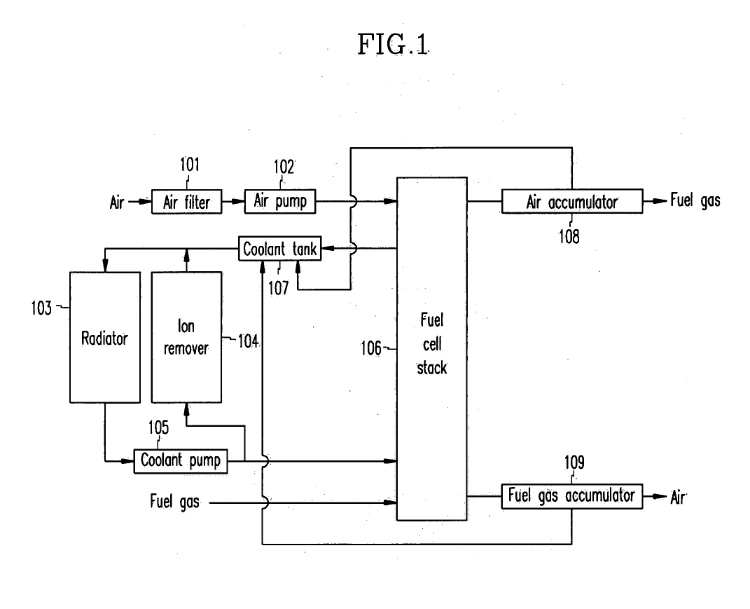

FIG. 1 illustrates a construction of a conventional fuel cell system.

As shown in FIG. 1, a fuel cell system has an air flow field, a fuel gas flow field, and a coolant flow field.

The air flow field has an air filter 101 for filtering induced air, an air pump 102 for applying a predetermined pressure to the introduced air, and an air accumulator 108 for condensation of air flowing from the fuel cell stack 106.

The air supplied to the air flow field flows through the air filter 101 from the air pump 102, and is inputted to the fuel cell stack 106 such that surplus air without having undergone electrochemical reaction is exhausted through the air accumulator 108.

The fuel gas supplied to the fuel gas flow field is inputted to the fuel cell stack 106 such that the surplus fuel gas without having undergone electrochemical reaction is exhausted through a fuel gas accumulator 109.

Meanwhile, the coolant circulates through the coolant flow field via a coolant tank 107, a radiator 103, a coolant pump 105, and an ion remover 104 such that the fuel cell stack 106 is cooled by heat exchange from the coolant.

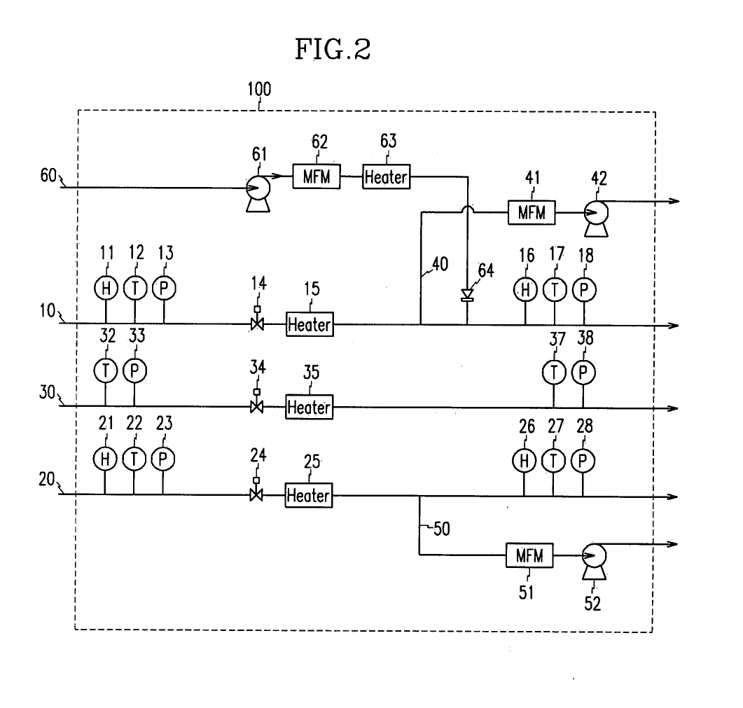

FIG. 2 is a construction of the fuel cell stack simulator according to an embodiment of this invention.

As shown in FIG. 1, the fuel cell stack simulator primarily has an air flow field 10, a fuel gas flow field 20, and a coolant flow field 30. A humidity sensor 11 for detecting humidity of supplied air, a temperature sensor 12 for detecting temperature of the supplied air, and a pressure sensor 13 for detecting a pressure of the supplied air are provided at an inlet of the air flow field 10. Also, a humidity sensor 16 for detecting humidity of exhausted air, a temperature sensor 17 for detecting temperature of the exhausted air, and a pressure sensor 18 for detecting a pressure of the exhausted air are provided at an outlet of the air flow field 10.

Meanwhile, a humidity sensor 21 for detecting humidity of supplied fuel gas, a temperature sensor 22 for detecting temperature of the supplied fuel gas, and a pressure sensor 23 for detecting a pressure of the supplied fuel gas are provided at an inlet of the fuel gas flow field 20.

A humidity sensor 26 for detecting humidity of exhausted fuel gas, a temperature sensor 27 for detecting temperature of the exhausted fuel gas, and a pressure sensor 28 for detecting a pressure of the exhausted fuel gas are provided at an outlet of the fuel gas flow field 20.

Furthermore, a temperature sensor 32 for detecting temperature of the supplied coolant and a pressure sensor 33 for detecting a pressure of the supplied coolant are provided at an inlet of the coolant flow field 30. A temperature sensor 37 for detecting temperature of the exhausted coolant, and a pressure sensor 38 for detecting a pressure of the exhausted coolant are provided at an outlet of the coolant flow field 30.

In the fuel cell stack, when the fluids such as air, fuel gas, and coolant are flowing in the flow field, pressure of each of the fluids is reduced. Accordingly, in order to simulate the reduction of the pressure, each of the flow fields 10, 20, 30 is provided with a control valve 14, 24, and 34.

Furthermore, when an electrochemical reaction between the air and the fuel gas occurs in the fuel cell stack, reaction heat is generated such that the temperatures of the exhausted air, the exhausted fuel gas, and the exhausted coolant from the fuel cell are increased.

In order to simulate heat generated during the electrochemical reaction, each of the flow fields 10, 20, and 30 is provided with a heater 15, 25, and 35 such that the heat generated during the electrochemical reaction is simulated by heat generated from the heater 15, 25, and 35.

Each of the control valves 14, 24, and 34 is controlled on the basis of the pressures at the inlet and the outlet of respective flow field 10, 20, and 30, such that the degree of the pressure reduction in each flow field 10, 20, and 30 of the simulator 100 can be determined by adjusting the control valves 14, 24, and 34.

Each of the heaters 15, 25, and 35 is controlled based on the temperatures at the inlet and the outlet of respective flow fields 10, 20, and 30, such that the amount of generated heat in each flow field 10, 20, and 30 of the simulator 100 can be determined by adjusting heaters 15, 25, and 35. [0029] Meanwhile, in the case of a fuel cell stack, the supplied air and the supplied fuel gas are consumed during the electrochemical reaction such that the surplus air and the surplus fuel gas, which are left in the fuel cell stack, are exhausted to outside of the fuel cell stack. In order to simulate consuming of the air and the fuel gas during the electrochemical reaction, an air-consumption field 40 is connected to the air flow field 10, and a fuel-gas-consuming field 50 is connected to the fuel gas flow field 20.

The air-consuming field 40 has a mass flow meter 41 for detecting the flow rate of the derived air, and a pump 42 for deriving a portion of the air flow in the air flow field 10. The pump 42 is controlled based on the flow rate detected by the mass flow meter 41, such that the amount of the derived air can be appropriately adjusted.

Similarly, the fuel-gas-consuming field 50 has a mass flow meter 51 for detecting the flow rate of the derived fuel gas, and a pump 52 for deriving a portion of the air flow in the air flow field 20. The pump 52 is controlled based on the flow rate detected by the mass flow meter 51, such that the amount of the derived fuel gas can be appropriately adjusted.

The amount of the derived air and the amount of the derived fuel gas is determined on the basis of a reaction formula of the electrochemical reaction between the fuel gas and the air in the fuel cell stack.

Furthermore, the fuel cell stack simulator 100 has a moisture-supplying field 60 for supplying moisture thereto. The moisture-supplying field is connected to the air flow field 10 in front of the heater 15. In the case of a fuel cell stack, water is generated during the electrochemical reaction between the fuel gas and the air. Accordingly, the moisture-supplying field 60 is connected to the air flow field 10 such that the water generated during the electrochemical reaction in the fuel cell stack is substituted with moisture injected from the moisture-supplying field 60 into the air flow field 10.

The moisture-supplying field 60 has a pump 61 for introducing water from outside, a mass flow meter 62 for detecting the flow rate of the supplied water, a heater 63 for heating the introduced water to the same temperature of the air in the air flow field 10, and an injector 64 for injecting the water into the air flow field 10 as moisture.

The pump 61 is controlled on the basis of the water flow rate detected by the mass flow meter 62, such that the amount of the introduced water for injecting can be appropriately adjusted. According to the fuel cell stack simulator, when estimating the performance of the BOP of the fuel cell system, a fuel cell stack is not required such that there is no possibility that the fuel cell stack can be damaged. Accordingly, a variety of conditions, which are intended to simulate operation of the fuel cell system, can be applied such that optimum conditions are easily determined. Furthermore, the fuel cell stack simulator has no membrane such that a pressure limitation, which is determined based on the kind of membrane, need not be considered, and the same type of fuel cell stack simulator can be adapted regardless of the pressures of the fluids.

Furthermore, although the fuel cell stack is operated under appropriate conditions, a fuel cell stack has a predetermined lifespan until it deteriorates. However the fuel cell stack simulator can be operated without deterioration, and it guarantees a relatively long lifespan.

1. A fuel cell stack simulator system comprising:
an air flow field supplied with air and exhausting remains of the supplied air after heating the supplied air and reducing the pressure of the supplied air;
a fuel flow field supplied with fuel gas and exhausting remains of the supplied fuel gas after heating the supplied fuel gas and reducing the pressure of the supplied fuel gas;
a coolant flow field supplied with coolant and exhausting the supplied coolant after heating the supplied coolant and reducing the pressure of the coolant;
a moisture-supplying field for supplying moisture into the fuel cell stack simulator;
an air-consuming field connected to the air flow field for reducing the pressure of heated air in said air flow field; and
a fuel-gas-consuming field connected to the fuel flow supplying field for reducing the pressure of heated fuel gas in said fuel flow field.

2. The fuel cell stack simulator of claim 1, wherein each of the air flow field, the fuel flow field, and the coolant flow field includes a control valve for reducing the pressure of flow therethrough, and a heater for heating the flow therethrough.

3. The fuel cell stack simulator of claim 1, wherein each of the air flow field, the fuel flow field, and the coolant flow field is provided with a temperature sensor and a pressure sensor disposed in an inlet and an outlet thereof.

4. The fuel cell stack simulator of claim 2, wherein each of the control valves is controlled based on the pressures detected by the pressure sensors.

5. The fuel cell stack simulator of claim 2, wherein each of the heaters is controlled based on the temperature detected by the temperature sensors.

6. The fuel cell stack simulator of claim 1, wherein each of the air-consuming field and the fuel-gas-consuming field has a mass flow meter for detecting the flow rate, and a pump for deriving a portion of the flow thereof.

7. A fuel cell stack simulator of claim 6, wherein the pump is controlled based on the flow rate detected by the mass flow meter.

8. The fuel cell stack simulator of claim 1, wherein the moisture-supplying field has a pump for introducing water, a mass flow meter for detecting the flow rate of the introduced water, a heater for heating the introduced water, and a injector for injecting the heated water into the air flow field in the form of moisture.

9. The fuel cell stack simulator of claim 8, wherein the pump of the moisture-supplying field is controlled based on the flow rate detected by the mass flow meter of the moisture-supplying field.
